(19) United States
(12) Patent Application Publication
(10) Pub. No.: US 2009/0091409 A1
(43) Pub. Date: Apr. 9, 2009

(54) CURVED BEAM CONTROL MAGNET

(76) Inventor: Gunter Ries, Erlangen (DE)

Correspondence Address: BRINKS HOFER GILSON & LIONE, P.O. BOX 10395, CHICAGO, IL, 60610, US

(21) Appl. No.: 12/297,374

(22) PCT Filed: Feb. 21, 2007
(86) PCT No.: PCT/EP2007/051642

§ 371 Date: Oct. 16, 2008

(30) Foreign Application Priority Data
Apr. 21, 2006 (DE) 102006018635.4

(51) Int. Cl. G21K 1/093

(52) U.S. Cl. 335/213

(57) ABSTRACT

A curved beam-guiding magnet is provided. The beam-guiding magnet without ferromagnetic material serves to deflect a beam of electrically charged particles along a curved particle path and incorporates a coil system made of at least six curved superconducting single coils arranged in pairs in mirror-inverted fashion relative to a beam-guiding plane. The coil system comprises two saddle-shaped main coils and two flat, banana-shaped curved secondary coils of the race-track type, each of which encloses a banana-shaped curved auxiliary coil of the race-track type. The beam-guiding magnet is particularly suitable for an irradiation unit of the gantry type.

The present patent document is a nationalization of PCT Application Serial Number PCT/EP2007/051642, filed Feb. 21, 2007, designating the United States, which is hereby incorporated by reference. This application also claims the benefit of DE 10 2006 018 635.4, filed Apr. 21, 2006, which is also hereby incorporated by reference.

### BACKGROUND

The present embodiments relate to a beam control magnet for deflecting a beam of electrically charged particles along a curved particle path.

German Patent Disclosure DE 199 04 675 A1 a radiation treatment system having a curved beam control magnet.

DE 199 04 675 A1 and U.S. Pat. No. 4,870,287 disclose curved beam control magnets used in particle accelerator systems for deflecting and/or focusing a beam of charged particles, such as electrons or ions. The systems can be designed for radiation therapy in the field of medical technology. The system includes a particle source or an accelerator for generating a high-energy particle beam. The high-energy particle beam emerges from the source in the direction of a radiation treatment axis and is aimed at an area of a subject that is to be irradiated, such as a patient's tumor. To reduce the radiation dose in the surrounding area, a gantry the beam is repeatedly deflected, by an arrangement of various deflecting and focusing magnets, out of the direction of the original radiation treatment axis, in such a way that the area to be irradiated is struck by the beam at a predetermined angle to this axis, such as an angle of 45 to 90°. The irradiation can be done from multiple sides. The magnet assembly includes deflecting and focusing magnets disposed on a frame of the gantry and is embodied rotatably about the original irradiation direction as an axis of rotation or axis of rotation of the gantry. The emerging beam always passes through a fixed point in the isocenter. Accordingly, the radiation exposure in the surrounding area or tissue can be limited by being distributed over a relatively large area.

German Patent Disclosure A1 discloses a gantry system with all the deflecting and focusing magnets with conductors of normally conducting material, such as copper (Cu). The windings of magnets with conductors of normally conducting material are relatively easy to make with this conductor material, since for shaping the magnetic fields that deflect and/or focus the beam, bodies or yokes of ferromagnetic material such as iron are used. The beam control magnets for deflection have water-cooled copper windings and corresponding iron yokes, for example. However, the magnetic flux density is limited by the saturation of the iron to a maximum of about 1.8 Teslas. The curve radius and length of the magnets generally used, with angles of deflection or curvature of 45° to 90°, are in the range of several meters, for irradiation with C⁶⁺ ions. With these dimensions, however, the weight of the iron yokes of the magnets is correspondingly high. The magnets of the gantry system, for example, have a total weight of about 95 metric tons. The requisite turret for the pivotable magnets of such a gantry system is stable and has exact beam control. If the magnet apparatus is large, as is needed for scanning-type deflection of a particle beam by the spot scanning method for gantry systems, the demand for electrical power and cooling water is quite considerable and in a gantry system is around 80 kW.

### SUMMARY AND DESCRIPTION

The present embodiments may obviate one or more of the drawbacks or limitations inherent in the related art. For example, in one embodiment, a beam control magnet for deflecting a beam of electrically charged particles along a curved particle path, such as for a radiation treatment system, has reduced values for its weight and size compared to corresponding normal-conducting magnets.

In one embodiment, a beam control magnet for deflecting a beam of electrically charged particles along a curved particle path is provided. The magnet includes a beam control plane that is fixed by the curved particle path; a curved beam control tube surrounding the curved particle path; and a system, associated with the beam control tube, of at least six curved superconducting individual coils, extending in the guidance direction of the particle beam, which are embodied and disposed in pairs in mirror symmetry to the beam control plane.

The beam control magnet may be free of ferromagnetic material affecting the beam guidance. The beam control magnet includes a beam control plane that is fixed by the curved particle path; a curved beam control tube surrounding the curved particle path; and a system, associated with the beam control tube, of at least six curved superconducting individual coils, extending in the guidance direction of the particle beam. The individual coils are disposed in pairs in mirror symmetry to the beam control plane. The coil system includes: two saddle-shaped primary coils with side parts elongated in the beam guiding direction and with end parts on the ends that are bent open, two at least largely flat secondary coils of the racetrack type that are curved in banana-like fashion and each surround an inner region, two at least largely flat additional coils of the racetrack type, curved in banana-like fashion and each disposed in the inner region of the respective secondary coil. The beam control magnet may also include thermal insulation and a cooling device for cooling the superconducting individual coils. The point of departure is the recognition that to be able to achieve a desired, predeterminable field quality in the beam range for the beam deflection, at least six cured individual coils are needed, if field-shaping parts comprising ferromagnetic material are to be dispensed with.

The beam control magnet, according to the preferred embodiments, may have a reduced weight and structural size. The weight and size may be important when heavy ions, such as C⁶⁺ ions, are to be used. For a gantry system with a 90° deflecting magnet and two 45° deflecting magnets for C⁶⁺ ions, for example, the magnet weight is approximately six metric tons (t), for a power consumption of several tens of kilowatts on the part of the requisite refrigeration machines. The space required can be reduced by half, and a pivoting frame for rotating the magnets around an axis of rotation of the gantry may be simpler and lighter in weight.

The beam control magnet may have a central angle of curvature that is between 30° and 90°. At relatively large angles of curvature, the weight reduction and smaller structural size compared to normal-conducting magnets is especially valuable.

The secondary coils may extend between the bent-open end parts of their respectively associated primary coil. Accordingly, a compact construction of the system including the individual coils can be achieved.

The conductors of the individual coils can have metal LTC (low T_{c}) superconducting material. The conductors, based for example, on NbTi, can be operated at very low temperatures and generally require helium cooling technology. They are technologically sophisticated and can be processed relatively simply.

The conductors of the individual coils can be made from metal oxide HTC (high T_{c}) superconducting material. Accordingly, the conductors, preferably in striplike shape, make higher operating temperatures possible, which may be between 10 K and 40 K, and preferably between 20 K and 30 K. Compared to the cooling technology for LTC superconductors, the effort and expense are correspondingly reduced. HTC superconductors, in the aforementioned temperature range, have sufficiently high critical current-carrying capacities and current densities for generating strong magnetic fields.

If a particle beam of C⁶⁺ ions that is to be deflected is contemplated, then in the case of these high-energy particles, the advantages of the reduction in weight and structural size are pronounced.

The beam control magnet can be embodied such that there is a magnetic aperture field intensity of at least 2 Teslas, and preferably between 3 and 5 Teslas. High aperture field intensities to be generated with superconductors are associated with the aforementioned advantages of the reduction in weight and structural size.

In one embodiment, a radiation treatment system includes a fixed radiation source that generates a beam of electrically charged particles, having a plurality of focusing magnets for focusing the particle beam, and having at least one beam control magnet according to the present embodiments.

The radiation treatment system has a fixed radiation source that generates a beam of electrically charged particles, a plurality of focusing magnets, and at least one beam control magnet for deflecting the particle beam. Such a system can be characterized by a gantry system with a rotatability of the magnets relative to an axis of rotation of the gantry that is located in the beam control plane. By the use of superconducting individual magnets, the structural size, weight, and power demand of the gantry system are reduced considerably, compared to normal-conducting magnets. A turret required for rotating the individual magnets can be simpler and lighter in weight.

### BRIEF DESCRIPTION OF THE DRAWINGS

Further advantageous features of the beam control magnet may become apparent from the drawings.

The present embodiments will be described in further detail below in conjunction with the drawings, which show a beam control magnet and a possible use in a radiation treatment system, without being restricted to the specific embodiment shown.

FIG. 1 shows a beam control magnet in perspective;

FIG. 2 shows the cross section through a beam control magnet;

FIG. 3 is a longitudinal section through a beam control magnet; and

FIG. 4 shows a basic layout of a gantry system, using a plurality of curved beam control magnets.

### DETAILED DESCRIPTION

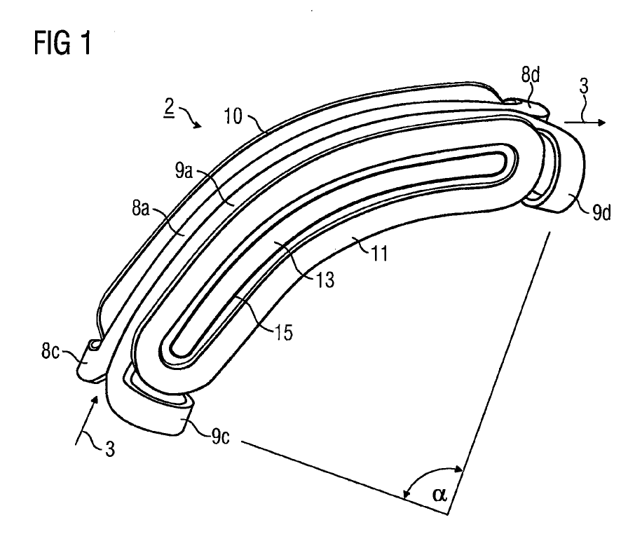

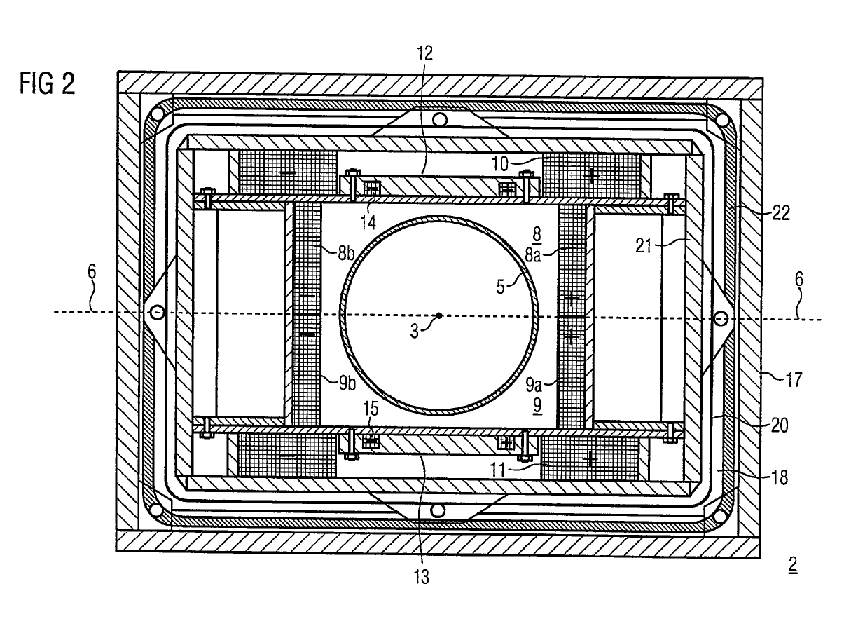

FIGS. 1 and 2 show a curved beam control magnet 2. he curved beam control magnet 2 may include corresponding magnets with normal-conducting coil windings, as used in particle accelerator technology. Elements not shown in the drawings are known.

The beam control magnet 1 serves to deflect a particle beam 3, represented by an arrow, by a central angle of curvature or arc angle α, which may be between 30° and 90° (that is, 30°≦α≦90°). The particle beam 3 is a beam of electrically charged particles, such as ions, in particular C⁶⁺ ions. The particle beam is kept and guided within a suitably curved beam control tube 5. The curved path of the particle beam defines a beam control plane 6, which is represented in FIG. 2 by a dashed line.

Superconductors are used to construct the magnet windings and coils of the beam control magnet 2. The superconductors can include metal LTC (low T_{c}) superconductor materials, such as NbTi, or also oxidic HTC (high T_{c}) superconductor materials. While a helium cooling technique is generally necessary for LTC superconductors at operating temperatures of about 4.2 K, for example, when HTC superconductors are used higher operating temperatures can be provided, for example, of 10 to 40 K, and preferably 20 to 30 K. At those temperatures, HTC superconductors have sufficiently high current densities for generating the requisite magnetic field intensity. For the requisite cooling of the superconductors, recourse can be had to refrigeration devices.

A system of at least six superconducting individual coils is provided. Of the six superconducting individual coils, two at a time are embodied and disposed in pairs in mirror symmetry to the beam control plane 6. Accordingly, in terms of individual coils, the system includes two elongated, saddle-shaped coils 8 and 9, hereinafter called primary coils. These coils each have two curved side parts 8a, 8b and 9a, 9b, respectively, extending laterally of the beam control tube 5, as well as end parts 8c, 8d and 9c, 9d on the face ends. The end parts on the face ends may be each bent or angled in such a way out of the plane defined by the side parts of the primary coil that they each extend semi-circularly around the outside of the beam control tube 5. The shaping of corresponding primary coils is generally known (see for example European Patent Disclosure EP 0 276 360 B1). Optionally, however, still other known saddle shapes are suitable, resting on a curved cylindrical jacket face. In other words, the side parts 8a, 8b and 9a, 9b need not each extend exactly in a non-curved plane and/or the ends 8c, 8d and 9c, 9d on the face ends need not each be embodied exactly semicircularly; instead, they may be parabola-like in shape (see for example Japanese Patent Disclosure JP 02-246305 A).

Above and below the beam control tube 5, located in parallel planes, two at least largely flat coils 10 and 11, curved in banana-like shape, hereinafter called secondary coils, are provided. These coils are designed as curved racetrack-shaped coils and may extend between the end parts, located on the face ends and shaped winding heads, of the primary coils 8 and 9. The shaping of corresponding secondary coils curved in banana-like fashion, for example, by approximately 90°, is also known (see for example European Patent Disclosure EP 0 185 955 B1 or German Patent Disclosure DE 35 04 211 A1). The conductors of the secondary coils 10 and 11 each surround one respective inner region 12 and 13 curved in banana-like fashion and in that region a correspondingly curved coil 14 and 15, respectively, also of the racetrack type, which may be called additional coils. As shown in FIG. 2, the winding cross section of these additional coils 14 and 15 is markedly less than that of the respective secondary coils 10 and 11 surrounding them. Also in FIG. 2, the current flow directions in the coils 10, 11, 14 and 15 are indicated.

Optionally, still further coils can be associated with the individual coils, for further improving the requisite field conditions, for example, with regard to homogeneity. With the minimum number of six coils, however, generally adequately satisfactory field conditions can be achieved.

Since as a result of suitable cooling devices, not shown, the superconducting individual coils 8, 9, 19, 11, 14, and 15 are at a cryogenic operating temperature. The superconducting individual coils 8, 9, 19, 11, 14, and 15 can be thermally insulated from the outer region of the beam control magnet, which is at room temperature. The thermal insulation, as shown in FIG. 2, include a warm outer housing, which is embodied as a vacuum or cryostat housing and encloses a vacuum chamber 18. Inside this vacuum chamber is a cold inner vessel 20, in which a mounting structure 21 is disposed for receiving and fixing the individual superconducting coils. Also inside this inner vessel, the requisite cooling power for cooling the individual superconducting coils must be made available to these coils. As shown in FIG. 2, other insulation, including discretely cooled insulation, such as radiation shields or insulating films 22, may be provided in the vacuum chamber 18 between the cold inner vessel 20 and the warm outer housing 17.

The individual windings of the beam control magnet are fixed mechanically in such a way that the forces acting on them are absorbed without causing unwanted motion on the part of the conductors.

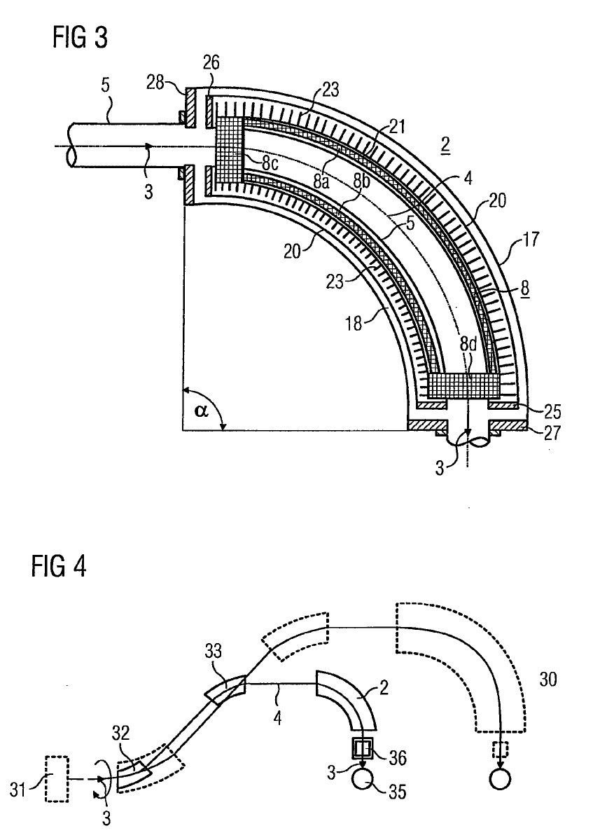

FIG. 3 shows a side view of the longitudinal section, taken through the beam control plane, though a corresponding beam control magnet 2 with a angle of curvature α of 90°. The winding heads and end parts may extend out of this plane, of one of the saddle-shaped primary coils, such as the semicircular end parts 8c and 8d of the coil 8. The winding heads and end parts are located inside the cold inner vessel 20, which serves, for example, to receive a liquid refrigerant, such as He or Ne. The inner vessel is equipped with face-end end flanges 25 and 26. Face-end end flanges 27 and 28 for the warm outer housing 17 are correspondingly provided.

The secondary coils 10 and 11 and the additional coils 14 and 15 are completely flat racetrack coils, located in one plane and curved in banana-like fashion. It is optionally also possible for at least some of these coils to be only approximately flat. At least in the region of their curved end parts, the coils may be bent open in saddle-like fashion. Accordingly, the coils are no longer located in a flat plane but on a jacket face of a cylinder that surrounds the curved beam control axis 4. Such coils can be made, for example, from initially flat, curved racetrack coils, by being adapted in form-locking fashion to the jacket face of the curved cylinder.

The curved beam control magnet 2 described in conjunction with FIGS. 1-3 is intrinsically suitable for arbitrary radiation treatment systems for deflecting beams of arbitrary electrically charged particles (see for example U.S. Pat. No. 4,870,287 or Japanese Patent Disclosure JP 2000-075100 A). A gantry system that is used for medical treatment may include the curved beam control magnet 2. The design characteristics of such systems are likewise well known (see for example DE 199 04 675 A1 or International Patent Disclosure WP 02/069350 A1). Such a system is distinguished in that the focusing and deflecting magnets on its ends may be pivoted about an axis of rotation of the gantry. Only the pivotable deflecting magnets of such a system are indicated, highly schematically, in FIG. 4. The gantry system 30 has a radiation source 32 for generating a beam 3 of ions, such as C⁶⁺ ions. These ions emerge from the source in a beam control direction that at the same time defines the axis of rotation A of the gantry. For example, with two 45° deflecting magnets 33 and 34, which may be like the curved beam control magnet 2, the ion beam 3 is put in a region that is remote from the axis A and from there, by a deflecting or beam control magnet 2, which deflects by 90°, for example, the beam that is aimed in a direction perpendicular to the axis of rotation A, where it intersects the axis A at an isocenter 34. Other combinations of deflecting magnets, such as one 45° magnet and one 135° magnet, or two 30° magnets and one 120 magnet, are also suitable. In the drawing, a diagnostic head, magnetically shielded by an iron box, for the beam location and the radiation dose is also indicated by reference numeral 36.

FIG. 4 shows a further magnet system 38. The further magnet system 38 is the system that would result if, instead of a system of superconducting magnets, one were to use normal-conducting magnets with field-shaping iron yokes. The isocenter would be approximately 1 m farther away from the ion source 31, assuming the values that can be found in the following table:

| Type | | |
|---|---|---|
| of embodiment | Conventional | Superconducting |
| Magnet technology | Cu conductors and iron | LTC or HTC conductors |
| Aperture field Bₘₐₓ | 1.8 Teslas | 4-5 Teslas |
| Field shaping | Iron yoke | Air coils without iron |
| Magnet mass | ca. 95 metric tons | ca. 6 metric tons |
| (one 90° magnet, | | |
| two 45° magnets) | | |
| Power consumption | 830 kW | 15-30 kW |
| at Bₘₐₓ | | |
| Gantry diameter × | 12 m × 18 m | 7 m × 12 m |
| gantry length | | |

From FIG. 4 and the above table, the advantage of using superconducting magnets in a gantry system as a radiation treatment system is immediately apparent.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A beam control magnet for deflecting a beam of electrically charged particles along a curved particle path, the beam control magnet being free of ferromagnetic material affecting the beam guidance, the beam control magnet including:
a beam control plane that is fixed by the curved particle path;
a curved beam control tube that surrounds the curved particle path;
a coil system of at least six curved superconducting individual coils, extending in the guidance direction of the particle beam, the at least six curved superconducting individual coils being disposed in pairs in mirror symmetry to the beam control plane, and
a thermal insulator and a cooling device that is operable to cool at least six curved superconducting individual coils,
wherein the coil system includes at least the following:
two saddle-shaped primary coils with side parts, elongated in the beam guiding direction, and end parts on the ends that are bent open,
two at least largely flat secondary coils of the racetrack type that are curved in bananalike fashion and each surround an inner region,
two at least largely flat additional coils of the racetrack type, curved in bananalike fashion and each disposed in the inner region of the respective secondary coil.

2. The beam control magnet as defined by claim 1, further comprising a central angle of curvature of between 30° and 90°.

3. The beam control magnet as defined by claim 1, wherein the secondary coils extend between the bent-open end parts of the associated primary coil.

4. The beam control magnet as defined by claim 1, wherein conductors of the at least six curved superconducting individual coils have metal LTC superconducting material.

5. The beam control magnet as defined by claim 1, wherein conductors of the at least six curved superconducting individual coils have metal oxide HTC superconducting material.

6. The beam control magnet as defined by claim 5, wherein an operating temperature of the conductors of the individual coils is between 10 K and 40 K.

7. The beam control magnet as defined by claim 1, wherein a beam of C⁶⁺ particles is to be deflected.

8. The beam control magnet as defined by claim 1, wherein a magnetic aperture field intensity in the beam control tube is at least 2 Teslas.

9. A radiation treatment system having a fixed radiation source that generates a beam of electrically charged particles, the radiation treatment system comprising:
a plurality of focusing magnets for focusing the particle beam, and
at least one beam control magnet for deflecting the particle beam,
wherein the at least one beam control magnet includes:
a beam control plane that is fixed by the curved particle path;
a curved beam control tube that surrounds the curved particle path;
a coil system of at least six curved superconducting individual coils, extending in the guidance direction of the particle beam, the at least six curved superconducting individual coils being disposed in pairs in mirror symmetry to the beam control plane, and
a thermal insulator and a cooling device that is operable to cool at least six curved superconducting individual coils,
wherein the coil system includes at least the following:
two saddle-shaped primary coils with side parts, elongated in the beam guiding direction, and end parts on the ends that are bent open,
two at least largely flat secondary coils of the racetrack type that are curved in bananalike fashion and each surround an inner region,
two at least largely flat additional coils of the racetrack type, curved in bananalike fashion and each disposed in the inner region of the respective secondary coil.

10. The radiation treatment system as defined by claim 9, further comprising a gantry having magnets that are operable to be rotated relative to an axis of rotation of the gantry that is located in the beam control plane.

11. The beam control magnet as defined by claim 1, wherein the operating temperature of the conductors of the individual coils is between 20 K and 30 K.

12. The beam control magnet as defined by claim 1, wherein a magnetic aperture field intensity in the beam control tube is between 3 and 5 Teslas.
